(19) United States
(12) Patent Application Publication
(10) Pub. No.: US 2007/0251512 A1
(43) Pub. Date: Nov. 1, 2007

(54) Integrated check valve breather

(75) Inventor: Scott A. Wallington, Sparland, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: CATERPILLAR INC.

(21) Appl. No.: 11/413,167

(22) Filed: Apr. 28, 2006

(51) Int. Cl. F02B 25/06; F02M 25/06

(52) U.S. Cl. 123/572

(57) ABSTRACT

A breather assembly may include a housing having an inlet for receiving crankcase emissions and an outlet for discharging the emissions, wherein the outlet is configured for direct connection to an exhaust system. The breather assembly may further include a check valve configured within an interior of the housing and a treatment element configured to treat emissions received from the crankcase.

### TECHNICAL FIELD

The present disclosure relates to control of crankcase emissions from an internal combustion engine and, more particularly, to a “breather” assembly that allows for venting of accumulated blow-by gases in the crankcase while separating crankcase oil from blow-by gases.

### BACKGROUND

In internal combustion engines, fuel and air may be introduced into cylinders for combustion. Pistons may move within the cylinders under the influence of a crankshaft located in a crankcase. In each cylinder, a piston may compress the fuel and air mixture prior to combustion of the mixture. Combustion may then drive the pistons and yield power output. The power output may be used to drive a machine.

Combustion in the cylinder may release energy and generate combustion products and by-products, most of which may be exhausted from the cylinder into an exhaust system of the engine during the exhaust phase of the combustion cycle. However, some of the combustion products may enter into the crankcase by blowing past seal rings around the pistons, and are thus termed “blow-by gases” or simply “blow-by.” Blow-by gases contain contaminants normally found in exhaust gases, such as, for example, hydrocarbons (HC), carbon monoxide (CO), nitric oxides (NOₓ), soot, and unburned or partially burned fuel. In addition, because the crankcase is partially filled with lubricating oil being agitated at high temperatures, the blow-by gases may also contain oil droplets and oil vapor. Lubricating oil in the crankcase tends to be atomized or otherwise entrained in the hot blow-by gases to form what may be termed an aerosol.

It may be desirable to vent blow-by gases in the crankcase (including, for example, entrained lubricating oil) as crankcase emissions to relieve pressure in the crankcase. Some systems vent the crankcase emissions to the air intake side of the engine for mixing with the air and fuel introduced into the cylinders. Those systems where the crankcase emissions are reintroduced into the engine for burning belong to the class of closed crankcase ventilation (CCV) systems.

Some engines, such as large diesel engines, for example, utilize forced induction to enhance the power output of the engine. This may involve the use of superchargers or turbochargers in an engine design assembly. Returning crankcase emissions to the air intake side of engine, such as via a compressor in a supercharger or turbocharger, can result in fouling of the components (e.g., the compressor wheel) in a relatively short time period. One effect of reintroducing blow-by gases into an intake air of an engine may include producing contaminant buildup (e.g., oil coatings and sludge), within engine components including, for example, turbochargers and cooling devices such as air-to-air aftercoolers (ATAAC). Contaminants, such as those left by blow-by gases, within engine sub-components can negatively affect, for example, power production of the engine and possibly reduce the operational life thereof. The fouling may be further compounded in systems which, for example, utilize multiple turbocharger systems, as the heat increases in downstream compressor units. Again, other components, such as cooling units downstream of a supercharger or turbocharger, may be fouled. Even with the development of technologies to address purifying crankcase emissions before being returned to the intake system, some level of contamination may still exist that may be harmful to engine components, such as a supercharger or turbocharger, cooling units, or various other engine intake system components.

U.S. Pat. No. 6,941,914 issued to Snyder et al. (“Snyder”) discloses an internal combustion engine having a CCV system including a breather assembly for venting blow-by gases from a crankcase. A breather conduit is connected to a hose fitting of the breather assembly to convey blow-by gases to the air filter cavity of the engine for recycling. However, the CCV system design of Snyder et al. may not address contamination issues that can result from recycling crankcase emissions through various engine components. Furthermore, it may be necessary to provide additional equipment, such as additional ventilation devices, in order to filter returned crankcase emissions. This can add to the manufacturing costs of the overall CCV system design. Use of additional equipment may also require additional servicing such as through periodic maintenance or replacement if the equipment becomes defective. Hence, additional servicing or maintenance costs may be associated with providing such additional equipment.

The present disclosure is directed towards overcoming one or more of the problems set forth above.

### SUMMARY OF THE INVENTION

In one aspect, the present disclosure may be directed to a breather assembly. The breather assembly may include a housing having an inlet for receiving crankcase emissions and an outlet for discharging the emissions, wherein the outlet is configured for direction connection to an exhaust system. The breather assembly may further include a check valve configured within an interior of the housing and a treatment element configured to treat emissions received from the crankcase.

In another aspect, the present disclosure may be directed to a method of venting emissions from a crankcase. The method may include providing a breather assembly having a check valve and an exhaust system, The method may further include coupling the breather assembly between the crankcase and the exhaust system and venting emissions from the crankcase, through the breather assembly, and directly to the exhaust system in a first flow direction.

In yet another aspect, the present disclosure may be directed to an engine assembly. The engine assembly may include a crankcase, a housing having an inlet for receiving crankcase emissions, and an outlet for discharging the emissions. The engine assembly may further include an exhaust system in direct connection with the outlet. The engine assembly may further include a check valve configured within an interior of the housing.

### BRIEF DESCRIPTION OF THE DRAWINGS

FIG. 1 provides a diagrammatic view of an engine according to an exemplary disclosed embodiment.

FIG. 2 provides a diagrammatic perspective view of a breather assembly according to an exemplary disclosed embodiment.

FIG. 3 provides a diagrammatic view of an engine assembly and breather assembly according to an exemplary disclosed embodiment.

FIG. 4 provides a diagrammatic detail view of the components of a breather assembly according to an exemplary disclosed embodiment.

FIG. 5 provides a diagrammatic cross-sectional view of a breather assembly according to an exemplary disclosed embodiment.

FIG. 6 provides a diagrammatic detail view of a support component of the breather assembly shown in FIG. 4.

### DETAILED DESCRIPTION

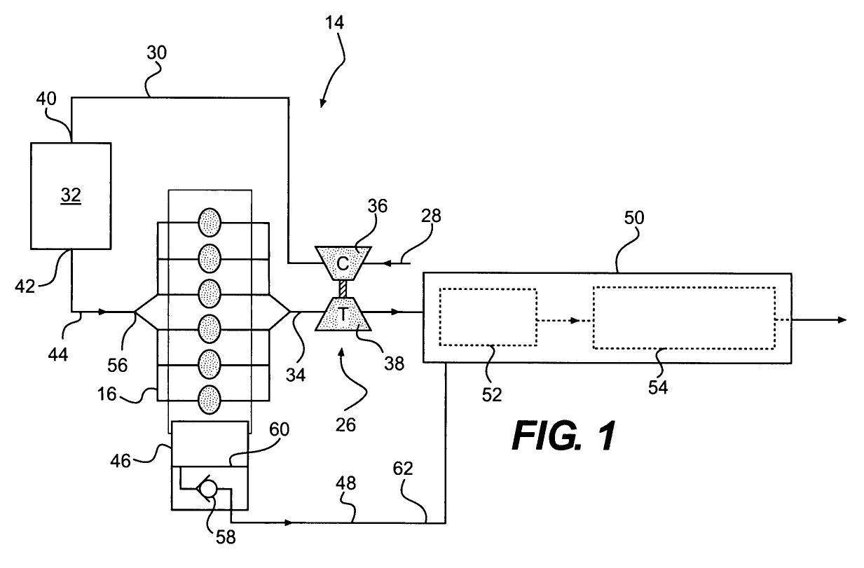

Referring to FIG. 1, an example of an engine 14 is illustrated. Engine 14 may be any type of engine, for example, an internal combustion engine of the gasoline, diesel, and/or gaseous fuel type. Engine 14 may be used to provide power to a drive assembly of a machine such as, via a mechanical or electric drive train. The machine could be any type of machine, e.g., stationary or mobile, such as an off-highway truck. Engine 14 may include a turbocharger 26 for compressing intake air 28 into heated charged air 30, and a cooler such as an air-to-air aftercooler (ATAAC) 32 for cooling the heated charged air 30 prior to entering an air intake manifold 56. Each of the engine sub-components may have a variety of configurations to suit a particular application. Exemplary sub-components of engine 14 will be discussed, but the presently disclosed system is not limited to these specific configurations.

Turbocharger 26 may include a compressor 36, powered by a turbine 38 driven by engine exhaust flow 34. The compressor 36 may pressurize intake air 28 to allow a greater mass of fuel/air mixture in the engine cylinders of engine 14. The result may be an increase in power and improved engine efficiency. However, as a byproduct of pressurization, the temperature of intake air 28 may also increase, which may be undesirable. As noted above, heated charged air 30 may be cooled prior to entering air intake manifold 56 by passing through ATAAC 32.

In one exemplary disclosed embodiment, heated charged air 30 from compressor 36 of turbocharger 26 may be admitted into ATAAC 32 through an inlet port 40. After traversing ATAAC 32 and having undergone a heat exchange operation with respect to relatively cool ambient air simultaneously passing over and around ATAAC 32, the previously heated charged air 30 may be exhausted through an outlet port 42 of ATAAC 32 as relatively cooled charged air 44, which may then be routed to engine air intake manifold 56. As shown in FIG. 1, engine air intake manifold 56 of engine 14 may include one or more passages or pipes which may be used to conduct cooled charged air 44 to one or more engine cylinders.

During operation, blow-by gases may build up in a crankcase 16 of the engine 14. A breather assembly 46, may be provided and coupled, for example, to crankcase 16 for venting blow-by gases 48 from the engine crankcase.

Thus, the disclosed embodiment shown in FIG. 1 illustrates breather assembly 46 directly coupled to an exhaust system 50, such as via conduit 62. In one exemplary disclosed embodiment, exhaust system 50 may include aftertreatment devices for receiving and treating not only engine exhaust flow 34, but blow-by gases 48 such as those expelled from breather assembly 46. These aftertreatment devices may include, for example, a regeneration system 52 and particulate filter 54 for treating engine and crankcase emissions prior to being released into the environment. While exemplary sub-components of exhaust system 50 have been described, the disclosed embodiment should not be limited to these specific configurations described herein.

Breather assembly 46 may include a filter media 60 which may include porous or mesh material. Filter media 60 may facilitate trapping of oil within an interior region of breather assembly 46 as blow-by gases 48 pass therethrough and towards exhaust system 50.

In order to prevent reverse flow of exhaust or blow-by gases 48 back into crankcase 16, a check valve 58 may be provided within breather assembly 46. In one embodiment, check valve 58 may include a reed or flapper type valve including, for example, flexible material such as spring steel. Check valve 58 may be orientated to allow blow-by gases 48 to escape from breather assembly 46, while preventing a reverse flow of blow-by gases 48 from entering crankcase 16 of engine 14 through the breather assembly 46.

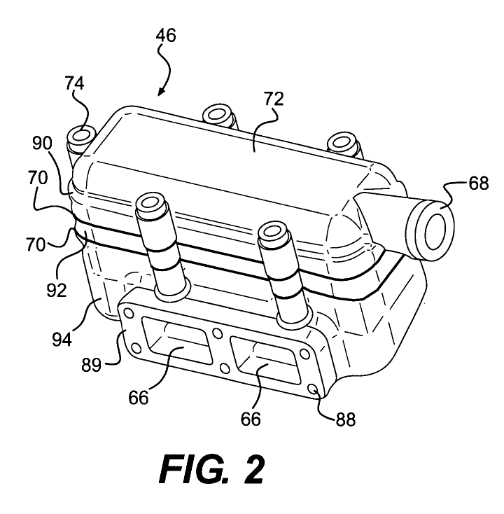

Turning to FIG. 2, breather assembly 46 is shown having a housing assembly 72. Housing assembly 72 may include a three part assembly including, for example, top support section 90, mid support section 92, and bottom support section 94. Gaskets 70, for example, including flexible or compressible material such as rubber or fibrous material may be inserted between each of the three sections 90, 92, 94. Inlet ports 66 may be generally configured along a side of bottom support section 94. Inlet ports 66 may receive blow-by gases 48, such as from crankcase 16 of engine 14. In one embodiment, an exterior surface region 89 may circumscribe inlet ports 66. Receiving holes 88 may be configured to receive respective retaining members such as threaded bolts. An outlet port 68 may be located at one end of top support section 90. The outlet port 68 may vent blow-by gases 48 out of breather assembly 46.

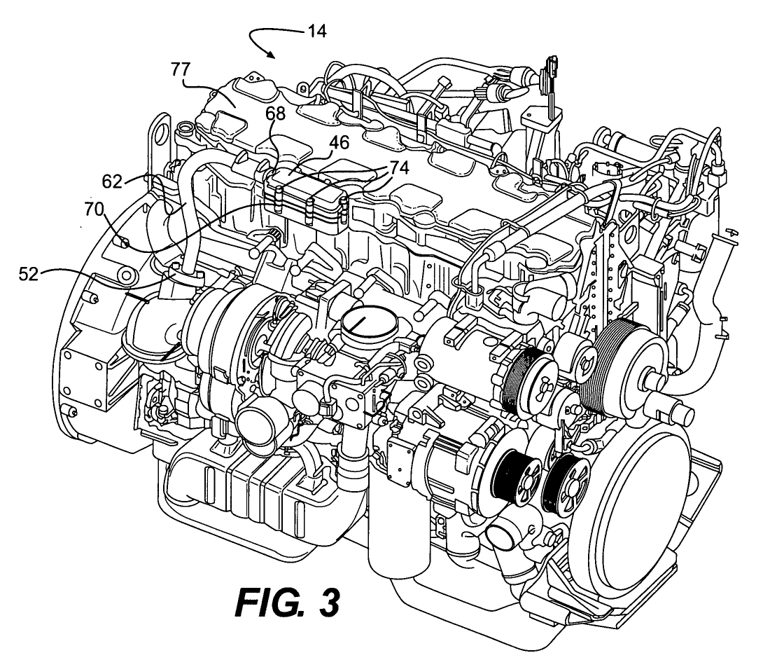

Turning to FIG. 3, a disclosed exemplary embodiment shows breather assembly 46 coupled to engine 14. In one embodiment, inlet ports 66 (FIG. 2) of breather assembly 46 are mounted flush to valve cover assembly 77. A suitable conduit 62 for directing blow-by gases 48 is shown coupled at one end to outlet port 68 of breather assembly 46. The other end of conduit 62 may be coupled to the regeneration system 52 of exhaust system 50. Thus, as crankcase 16 of engine 14 becomes pressurized, blow-by gases 48 may be vented from valve cover assembly 77 of engine 14 through breather assembly 46 into the regeneration system 52.

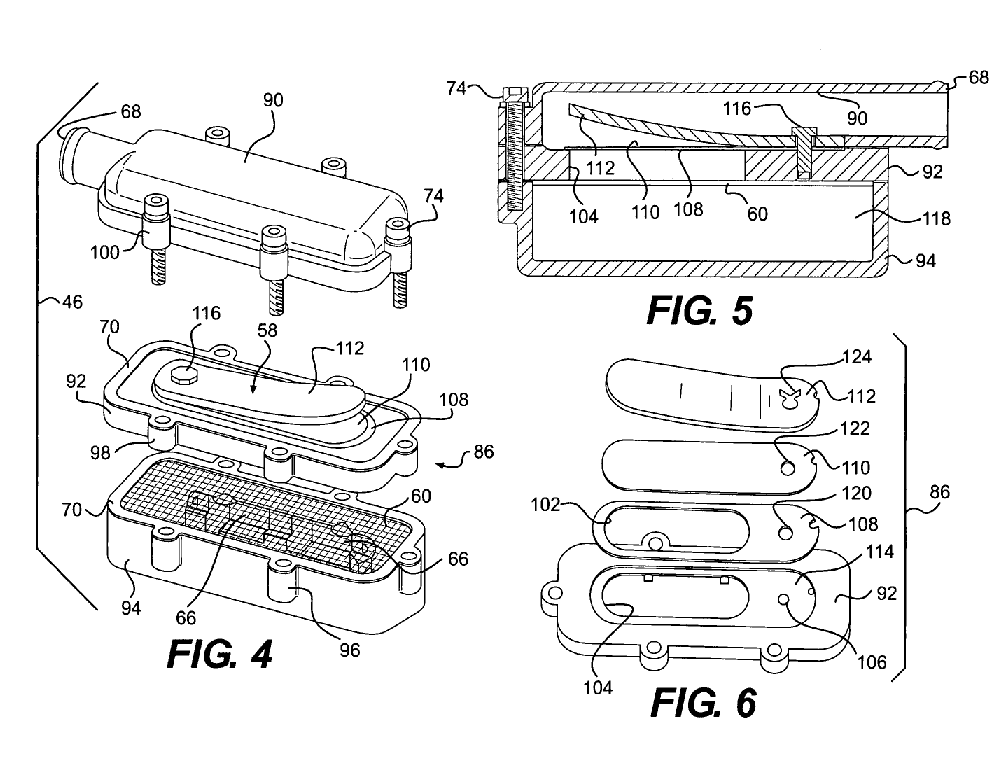

FIGS. 4-6 illustrate various components which may be included within an exemplary embodiment of breather assembly 46. Turning to FIG. 4, top support section 90, mid support section 92, and bottom support section 94 are shown relative to one another and positioned for assembly. Top support section 90 may include bolt receiving apertures 100 for receiving bolts 74 therethrough. Similarly, mid support section 92 and bottom support section 94 may include bolt receiving apertures 98 and 96, respectively, for receiving bolts 74 therethrough. Bolt receiving apertures 100, 98, 96 may be located relative to one another in alignment to receive bolt 74. In one disclosed embodiment, bolt receiving aperture 96 may threadedly receive bolt 74 in order to retain the bolt 74 therein. Thus, bolt 74 may pass successively through bolt receiving apertures 100, 98, 96 and be retained therein.

Gasket 70 is shown in alignment with mid support section 92, and, in the disclosed embodiment, is disposed between mid support section 92 and top support section 90 in a final assembly. Mid support section 92 may include installed components of a reed valve assembly 86 in accordance with an exemplary embodiment of the disclosure. Respective components of reed valve assembly 86 are shown more easily in FIG. 6. Mid support section 92 may include a recessed portion 114 for receiving valve seat 108. A receiving hole 106 may be disposed within recessed portion 114 to receive retaining member 116 (FIG. 4) in a final assembly. In one embodiment, retaining member 116 may include a threaded bolt member. Receiving hole 106 may include mating threads for receiving a threaded configuration of retaining member 116. Mid support section 92 may also include opening 104, such as within recessed portion 114, for venting blow-by gases 48 received through inlet ports 66 (FIG. 4) and an inner chamber 118 (FIG. 5) of breather assembly 46.

Reed valve element 110 may be provided and orientated to allow blow-by gases 48 to escape from breather assembly 46, while preventing a reverse flow of blow-by gases 48 from entering crankcase 16 of engine 14 through the breather assembly 46. Valve seat 108, made of a rigid material, may assist in prolonging the lifespan of reed valve element 110 such as by preventing excessive wear. Additionally, valve seat 108 may enhance a flat mating surface of reed valve element 110 in a final assembly. Furthermore, valve seat 108 (in combination with recessed portion 114 of mid support section 92) may facilitate preventing reed valve element 110 from flexing in an open configuration should blow-by gases 48 attempt to re-enter breather assembly 46 (such as in a reverse flow direction through output port 68) as discussed below. Valve seat opening 102, such as one corresponding to opening 104 of mid support section 92, may also be included in valve seat 108. In similar fashion, valve seat opening 102 may accommodate vented blow-by gases 48 received through inlet ports 66 (FIG. 4) and inner chamber 118 (FIG. 5) of bottom support section 94. Finally, valve seat 108 may also include opening 120 to receive retaining member 116 (FIG. 4) in a final assembly.

Reed valve element 110 may be seated upon valve seat 108. Reed valve element 110 may include spring steel material. Alternatively, reed valve element 110 may include other materials suitable for venting blow-by gases such as including synthetic resin material. In one disclosed embodiment, reed valve element 110 (such as one including spring steel material) may have a thickness of approximately 0.305 mm ( 12/1000 inch). Other suitable thicknesses of reed valve element 110 may be utilized which may not only prevent reverse flow but also remain pliable for responding to appropriate crankcase pressure to vent blow-by gases 48. Reed valve element 110 may include opening 122 for receiving retaining member 116 (FIG. 4) in a final assembly.

Valve stop 112, made of a rigid material such as steel, may be seated upon reed valve element 110. A configuration of valve stop 112 may include a slightly curved configuration. An opening 124 may be provided within valve stop 112 for receiving retaining member 116 (FIG. 4) in a final assembly. In one embodiment, valve stop 112 may include a slightly curved configuration to prevent over-deflection of reed valve element 110 in a direction towards valve stop 112 as blow-by gases 48 are vented from inner chamber 118 towards outlet port 68 (FIG. 5). A more detailed description of the movement of reed valve element 110 in response to a flow direction of blow-by gases 48 is presented below.

Turning again to FIG. 4, a final assembly of mid support section 92 may include valve seat 108 seated upon recessed portion 114 (FIG. 6) of mid support section 92, reed valve element 110 seated upon valve seat 108, and valve stop 112 seated upon reed valve element 110. A disclosed embodiment may include respective openings 106, 120, 122, and 124 (FIG. 6) in alignment to successively receive retaining member 116 therein. Retaining member 116 may facilitate retaining mid support section 92, valve seat 108, reed valve element 110 and valve stop 112 in a fixed position with respect to one another.

As further shown in FIG. 4, bottom support section 94 may include filter media 60. Gasket 70 is shown in alignment with bottom support section 94, and, in the disclosed embodiment, is disposed between mid support section 92 and bottom support section 94 in a final assembly.

### INDUSTRIAL APPLICABILITY

The disclosed breather assembly 46 may have applicability in any system requiring the venting of a emissions. In addition, breather assembly 46 may have applicability in any system requiring protection from vented gas. For example, the disclosed breather assembly 46 may be used in connection with internal combustion engines. In particular, and as shown in FIG. 1, breather assembly 46 may serve to vent blow-by gases 48 from crankcase 16 of engine 14 while preventing vented blow-by gases 48 from returning to engine components. Thus, protection of engine components from vented gases may be achieved utilizing an efficient and cost-effective setup which may be provided by the disclosed embodiment. The setup, described herein, may further aid in increasing the service life of engine components.

Having achieved a final assembly in connection with an engine 14 and directly coupled to exhaust system 50, breather assembly 46, of the disclosed embodiment, may be configured to receive blow-by gases 48, filter the received gases, and emit the filtered gases directly to exhaust system 50. An effect of routing crankcase emissions directly to exhaust system 50, as described herein, may produce an increased pressure within crankcase 16 of engine 14. Hence, the crankcase pressure obtained by the disclosed embodiment may achieve pressures greater than CCV systems which route blow-by gases to the intake system of the engine. In one example, the crankcase pressure achieved by the disclosed embodiment may be on an order of 5 psi or greater. Whereas, comparatively, some traditional CCV systems (e.g., those routing blow-by gases 48 to the intake system) may produce a crankcase pressure generating only a fraction of 1 psi. Thus, the arrangement of the disclosed embodiment is conducive to creating a flow direction of blow-by gases in order to expel the gases from crankcase 16, into and through breather assembly 46, and towards exhaust system 50. Reducing exposure of high temperature blow-by gases to engine components, such as through venting, may be beneficial for protecting the components against gases which may achieve elevated temperatures. The aforementioned flow direction may also be desirable to prevent high temperature exhaust gases from coming into contact with engine components and possibly creating damage thereto.

In general, the aforementioned flow direction may exist so long as greater pressure is produced and maintained within crankcase 16 than within the exhaust system 50. If the pressure within crankcase 16 is less than the pressure in exhaust system 50, engine exhaust gases will travel towards the lower pressure within crankcase 16 in a reverse flow direction. Reverse flow of exhaust gases back into engine 14 may not be desirable for several reasons. One reason may include risk of damage caused by thermal effects of exhaust gases returning into contact with engine components. Since exhaust gases can reach relatively high temperatures (e.g., 500° C. or greater), it may be possible to cause damage, for example, to engine components should the aforementioned gases make contact in a reverse flow direction. In one example, exhaust gases may melt engine components, such as valve covers of engine 14. Additionally, engine components that come into contact with exhaust gases may be susceptible to corrosive effects. This, in turn, could reduce the operational life of those components.

Check valve 58, configured within breather assembly 46, prevents reverse flow of exhaust gases back into crankcase 16. Hence, check valve 58 may be orientated to allow blow-by gases 48 to escape from breather assembly 46 while preventing a reverse flow of engine exhaust gases 48 from entering a crankcase of engine 14 when the pressure in the exhaust system 50 is greater than crankcase 16.

In operation, blow-by gases 48, in one exemplary embodiment, may pass around pistons from combustion chambers into crankcase 16 during operation of engine 14. The blow-by gases 48 may tend to accumulate within crankcase 16 and increase the pressure therein. When appropriate pressurization of crankcase 16 occurs (such as when the pressure within crankcase 16 overcomes the pressure of exhaust system 50), blow-by gases 48 may be vented by entering into inlet ports 66 of breather assembly 46. Blow-by gases 48 may accumulate within an inner chamber 118 and be filtered through filter media 60. Within inner chamber 118, oil may separate from blow-by gases 48 by gravity and condensation and drip back into the crankcase. In addition, oil may be trapped within filter media 60. Blow-by gases 48 may then pass through opening 104 and valve seat opening 102, past reed valve element 110, and vented through outlet port 68.

Discharge of blow-by gases 48 in the described manner may cause reed valve element 110 to deflect away from valve seat opening 102 and towards valve stop 112. This action may facilitate venting of blow-by gases 48 from crankcase 16. Conduit 62 may couple outlet port 68 of breather assembly 46 to exhaust system 50 in order to convey blow-by gases 48 to the exhaust for treatment and/or release into the environment.

When a pressurization of the crankcase is not sufficient to overcome pressurization of exhaust system 50, reed valve element 110 may serve to protect against emitting engine exhaust gases 48 back into crankcase 16 through breather assembly 46. Engine exhaust gases in reverse flow may exert a force upon reed valve element 110 such that reed valve element 110 is deflected toward valve seat 108. The biasing force produced by the exhaust gases may facilitate deflecting reed valve element 110 to cover valve seat opening 102. This action will cause passage of exhaust gases through valve seat opening 102 to become blocked. The relatively flat configuration of valve seat 108, provided by the disclosed embodiment, may further assist in providing better coverage/sealing of valve seat opening 102 by reed valve element 110 to prevent exhaust gases from entering inner chamber 118. With the reverse flow of exhaust gases cut off by reed valve element 110, exhaust gases may be prevented from re-entering crankcase 16. Thus, the disclosed embodiment may ensure protection against exhaust gases re-entering and passing through breather assembly 46 and coming into contact with components of engine 14. As previously mentioned, such contact may result in damage to engine components exposed, for example, to increased heated temperatures of returning engine exhaust gases. Utilizing disclosed breather assembly 46 in combination with check valve 58, may also prevent, or greatly reduce, corrosive effects of engine components generated, in some instances, by contact with returned exhaust gases. Hence, the disclosed embodiment may facilitate increased operational life of engine components.

It will be apparent to those skilled in the art that various modifications and variations can be made in the disclosed breather assembly and methods without departing from the scope of the disclosure. Additionally, other embodiments of the breather assembly and methods will be apparent to those skill in the art from consideration of the specification. It is intended that the specification and examples be considered as exemplary only, with a true scope of the disclosure being indicated by the following claims and their equivalents.

What is claimed is:

1. A breather assembly, comprising:
a housing having an inlet for receiving crankcase emissions and an outlet for discharging the emissions wherein the outlet is configured for direct connection to an exhaust system;
a check valve configured within an interior of the housing; and
a treatment element configured to treat emissions received from the crankcase.

2. The breather assembly of claim 1, wherein the check valve includes a reed valve.

3. The breather assembly of claim 1, wherein the check valve obtains a closed configuration when a pressure downstream to the check valve is greater than a pressure upstream to the check valve.

4. The breather assembly of claim 1, wherein the emissions discharged from the outlet is supplied to the exhaust system downstream to a turbocharger.

5. The breather assembly of claim 1, wherein the housing includes three assembly sections joined together, wherein the three assembly sections include a first assembly section, a second assembly section, and a third assembly section.

6. The breather assembly of claim 5, wherein the outlet is disposed on the first assembly section.

7. The breather assembly of claim 5, wherein the check valve is disposed within the second assembly section.

8. The breather assembly of claim 7, wherein the check valve includes a reed valve assembly.

9. The breather assembly of claim 8, wherein the second assembly section includes a recessed portion and the reed valve assembly is disposed and retained within the recessed portion.

10. The breather assembly of claim 5, wherein the inlet is disposed on the third assembly section and the treatment element is disposed within the third assembly section.

11. The breather assembly of claim 10, wherein the treatment element includes a filter media of porous or mesh material.

12. The breather assembly of claim 10, wherein the reed valve assembly includes a valve seat, a reed valve disposed upon the valve seat, and a reed valve stop disposed upon the reed valve.

13. A method of venting emissions from a crankcase of an engine, comprising:
providing a breather assembly having a check valve;
providing an exhaust system;
coupling the breather assembly between the crankcase and the exhaust system; and
venting emissions from the crankcase, through the breather assembly, and directly to the exhaust system in a first flow direction.

14. The method of claim 13, further including supplying the emissions vented through the breather assembly to the exhaust system downstream to a turbocharger.

15. The method of claim 13, further including closing the check valve when a pressure downstream to the breather assembly is greater than a pressure upstream to the breather assembly.

16. An engine assembly, comprising:
a crankcase;
a housing having an inlet for receiving crankcase emissions and an outlet for discharging the emissions;
an exhaust system in direction connection with the outlet; and
a check valve configured within an interior of the housing.

17. The engine assembly of claim 16, wherein the emissions discharged from the outlet is supplied to the exhaust system downstream to a turbocharger.

18. The engine assembly of claim 16, further including a treatment element configured to treat the emissions received from the crankcase.

19. The engine assembly of claim 16, wherein the check valve obtains a closed configuration when a pressure downstream to the check valve is greater than a pressure upstream to the check valve.

20. The engine assembly of claim 16, wherein the check valve includes a reed valve assembly.
